(19) United States
(12) Patent Application Publication
(10) Pub. No.: US 2006/0020562 A1
(43) Pub. Date: Jan. 26, 2006

(54) Apparatus and method for estimating optical flow

(75) Inventor: Beddhu Murali, Petal, MS (US)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(73) Assignee: University of Southern Mississippi

(21) Appl. No.: 10/896,742

(22) Filed: Jul. 21, 2004

(51) Int. Cl. G06F 15/18

(52) U.S. Cl. 706/12

(57) ABSTRACT

An apparatus and method for estimating optical flow use equations derived by setting the deformation tensor to zero.

### BACKGROUND OF THE INVENTION

The present invention is directed to apparatus and methods for computing structure from motion. More particularly, the present invention is directed to apparatus and methods for determining optical flow for semi-rigid body motions.

Optical flows that are induced in the image plane due to rigid body motions, either of the observing camera or of the objects in a scene, have been studied extensively in the literature. Approaches based solely on the so-called optical flow constraint result in an underdetermined system, which is usually solved using error-minimizing algorithms. Thus, unique or physically accurate solutions are not guaranteed. Several ad hoc approaches that introduce additional equations, which result in unique optical flow solutions, also exist. However, these approaches do not guarantee physically accurate results.

The need to compute structure from motion occurs in several important applications such as machine vision, three-dimensional surface reconstruction, autonomous navigation etc. In order to compute structure from motion, Horn and Schunk (Determining Optical Flow, Artificial Intelligence, 17(1-3), 185-203, (1981)) first introduced the optical flow constraint, which is also known as the Hamilton-Jacobi equation in a two-dimensional plane. Since there was only one equation and two unknowns (the horizontal and vertical components of the optical flow velocity), the resulting formulation was called the optical flow constraint approach. Considering a translating and rotating camera, Longuet-Higgins, (The visual ambiguity of a moving plane, Proc. Royal Soc. London, B-223, 165-175, (1984)) introduced for the first time explicit relationships between the image plane optical flow velocity components and the rigid body rectilinear and angular velocity components of the moving camera.

In the famous book by Horn (Robot Vision, The MIT Press, (1986)), one finds two approaches, which differ in the details but stem from the basic idea of minimizing a functional in order to obtain the additional constraints. In Section 12.3, page 284, smoothness assumptions are made about the optical flow velocity components, which lead to a set of two equations for the two velocity components. These equations are valid for non-rigid body motions. In Sections 17.3-17.5 of Horn, one can find treatments for rigid body translation, rigid body rotations, and the general rigid body rotation (which is a combination of rotation and translation) respectively. In all these cases, a functional is introduced based on the difference between calculated optical flow velocity components and expected velocity components based on the Longuet-Higgins equations. The methods in the book by Horn neither utilize the condition that the deformation tensor is zero nor include the depth as an additional unknown as done in this patent application.

Suppose one has two different still images of a scene and one can identify at least six corresponding points in the two images then Longuet-Higgins has suggested an approach to construct the three dimensional structure of the scene from this information. This basic idea has been further refined in several papers and one of the recent work can be found in Azarbayejani and Pentland (Recursive Estimation of Motion, Structure and Focal Length, Perceptual Computing Technical Report #243, MIT Media Laboratory, July (1994)). They use a least square minimization algorithm, which is implemented using an Extended Kalman Filter (EKF). A recent discussion of this algorithm can be seen in Jabera, Azarbayejani and Pentland (3D Structure from 2D Motion, IEEE Signal Processing Magazine, Vol. 16, No. 3, May (1999)).

A comparison of nine different techniques including differential methods, region-based matching methods, energy-based methods, phase-based methods proposed by Horn and Shunk (Robot Vision, The MIT Press, (1986)), Lucas and Kanede (An Iterative Image Registration Technique with an Application to Stereo Vision, Proc. of DARPA IU Workshop, pp. 121-130, (1981)), Uras et al. (Computational Approach to Motion Perception, Biol. Cybern. 60, pp. 79-97, (1988)), Nagel (On the Estimation of Optical Flow: Relations between Different Approaches and Some New Results, AI 33, pp. 299-324, (1987)), Anandan (A Computational Framework and an Algorithm for the Measurement of Visual Motion, Int. J. Computer Vision, 2, pp. 283-310, (1989)), Singh (Optical Flow Computation: A Unified Perspective, IEEE Computer Society Press (1992)), Heegar (Optical Flow Using Spatiotemporal Filters, Int. J. Comp. Vision, 1, pp. 279-302, (1988)), Waxman et al (Convected Activation Profiles and Receptive Fields for Real-Time measurement of Short Range Visual Motion, Proc. of IEEE CVPR, Ann Arbor, pp. 717-723, (1988)), and Fleet and Jepsen (Computation of Component Image Velocity from Local Phase Information, Int. J. Comp. Vision, 5, pp. 77-104, (1990)) has been carried out by Barren et al (Performance of optical flow techniques. International Journal of Computer Vision, 12(1) pp. 43-77, (1994)). While all these methods use different variation of the minimization idea, none of them include the physics-based condition that the deformation tensor is zero.

A probabilistic method to recover 3D scene structure and motion parameters is presented in Delleart et al (F. Dallaert, S. M. Seitz, C. E. Thorpe, and S. Thrun, Structure from motion without correspondence, (2001)). Integrating over all possible mapping/assignments of 3D features to 2D measurements a maximum likelihood of structure and motion is obtained in this method.

Brooks et al (Determining the Egomotion of an Uncalibrated Camera From Instantaneous Optical flow, Journal Optical Society of America A, 14, 10, 2670-2677, (1997)) propose an interesting approach that leads to the so-called differential epipolar equation. It can be shown that the differential epipolar equation can easily be derived from the geometric conservation law (P. D. Thomas and C. K. Lombard, Geometric conservation law and its application to flow computations on moving grids, AIAA J., 17, pp. 1030-1037 (1979)). While their approach is an alternate approach to the optical flow based approaches, they do not use the condition of zero deformation tensor.

Until now, a consistent formulation that utilizes the optical flow constraint of Horn and Schunk along with the formulation of Longuet-Higgins in order to develop physics-based supplementary equations is not available in the prior art. The present invention relates the above two formulations utilizing the idea that the deformation tensor is zero for rigid body motions. While setting deformation tensor equal to zero results in six equations, the present formulation utilizes only three of them thus allowing semi-rigid motion in the plane parallel to the image plane.

### SUMMARY OF THE INVENTION

A new method based on the observation that the deformation tensor for rigid body motions is zero is presented. It leads to two additional equations, which can be solved for obtaining unique and physically accurate results. The governing equations are singular at the origin (a fact documented in the literature) and they do not explicitly depend upon the focal length for small radial distances.

### DESCRIPTION OF ILLUSTRATING EMBODIMENTS

Deformation Tensor

For rigid body motions, it is easy to verify that the deformation tensor (also called the rate of strain tensor in fluid mechanics) is zero. This statement can be expressed as

$$\tilde{D} = \frac{1}{2} [ grad {U}^{->} + {( grad {U}^{->} )}^{T} ] = 0 \qquad ( 1 )$$

where \tilde{D} is the deformation tensor and \vec{U} is the velocity vector. Because of the symmetry of \tilde{D}, Eq. (1) actually only represents six independent equations. In terms of a set of Cartesian coordinates X, Y and Z, and Cartesian components U, V, and W of \vec{U}, these six equations can be written as

$$\begin{matrix}\frac{\partial U}{\partial X} = 0 & ( 2 ) \\ \frac{\partial V}{\partial Y} = 0 & ( 3 ) \\ \frac{\partial W}{\partial Z} = 0 & ( 4 ) \\ \frac{\partial U}{\partial Y} + \frac{\partial V}{\partial X} = 0 & ( 5 ) \\ \frac{\partial U}{\partial Z} + \frac{\partial W}{\partial X} = 0 & ( 6 ) \\ \frac{\partial V}{\partial Z} + \frac{\partial W}{\partial Y} = 0 & ( 7 )\end{matrix}$$

The goal of the following sections is to derive additional equations that govern the optical flow by relating Eqs. (4), (6) and (7) to the image plane optical velocity components, which are obtained by taking the time derivatives of the epipolar transformations. These additional equations are to be used in conjunction with the well-known optical flow constraint in order to obtain a unique optical flow velocity solution at each instant of time. In addition, the resulting equations also allow the 3D reconstruction of the scene.

The formulation presented next does not impose Eqs. (2), (3) and (5). In other words, the RHS of these equations can be non-zero. Thus, this formulation allows semi-rigid motion in the X-Y plane.

Epipolar Geometry

In epipolar geometry, the coordinates X, Y, Z of the material point Mare projected to the epipolar coordinates x, y, z according to

$$\begin{matrix}x = \frac{fX}{Z} & ( 8 ) \\ y = \frac{fY}{Z} & ( 9 ) \\ z = f & ( 10 )\end{matrix}$$

where f is the focal length of the camera and x and y are the image plane coordinates.

Using Eqs. (8) and (9), one can obtain the following relationships

$$\begin{matrix}\frac{\partial x}{\partial X} = \frac{f}{Z} - \frac{x}{Z} \frac{\partial Z}{\partial X} ; \frac{\partial x}{\partial Y} = - \frac{x}{Z} \frac{\partial Z}{\partial Y} ; \frac{\partial x}{\partial Z} = - \frac{x}{Z} & ( 11 ) \\ \frac{\partial y}{\partial X} = - \frac{y}{Z} \frac{\partial Z}{\partial X} ; \frac{\partial y}{\partial Y} = \frac{f}{Z} - \frac{y}{Z} \frac{\partial Z}{\partial Y} ; \frac{\partial y}{\partial Z} = - \frac{y}{Z} & ( 12 ) \\ u = \frac{ⅆ x}{ⅆ t} = \frac{fU - xW}{Z} & ( 13 ) \\ v = \frac{ⅆ y}{ⅆ t} = \frac{fV - yW}{Z} & ( 14 )\end{matrix}$$

The derivatives in Eqs. (11) and (12) have been obtained assuming that the surface to be reconstructed can be expressed as Z=Z(X, Y). Otherwise, note that, setting

$$\frac{\partial x}{\partial X} = \frac{f}{Z} ; \frac{\partial x}{\partial Y} = \frac{\partial y}{\partial X} = 0 ; \frac{\partial y}{\partial Y} = \frac{y}{Z}$$

results in

$$\frac{\partial U}{\partial x} = \frac{\partial V}{\partial y} = 0 ,$$

which, taken together with Eqs. (6) and (7), imply that Z=Constant. The quantities u and v appearing in Eqs. (13) and (14) are the instantaneous image plane velocity components in the x and y directions respectively of the projection of a material point M on the image plane. They are the optical flow velocity components.

In terms of the image plane coordinates x and y, Eq. (4) can be rewritten as

$$\frac{\partial W}{\partial x} \frac{\partial x}{\partial Z} + \frac{\partial W}{\partial y} \frac{\partial y}{\partial Z} = 0 \qquad ( 15 )$$

Using the relationships in Eqs. (11) and (12) in Eq. (15), one obtains

$$x \frac{\partial W}{\partial x} + y \frac{\partial W}{\partial y} = 0 \qquad ( 16 )$$

Also, from Eqs. (6) and (7), using Eqs. (11) and (16), one obtains

$$\begin{matrix}x \frac{\partial U}{\partial x} + y \frac{\partial U}{\partial y} = f \frac{\partial W}{\partial x} & ( 17 ) \\ x \frac{\partial V}{\partial x} + y \frac{\partial V}{\partial y} = f \frac{\partial W}{\partial y} & ( 18 )\end{matrix}$$

Equations (17) and (18) can be combined using Eq. (16), which results in

$${x}^{2} \frac{\partial U}{\partial x} + xy ( \frac{\partial U}{\partial y} + \frac{\partial V}{\partial x} ) + {y}^{2} \frac{\partial V}{\partial y} = 0 \qquad ( 19 )$$

From Eqs. (13) and (14) one obtains

$$\begin{matrix}\frac{\partial ( Zu )}{\partial x} = f \frac{\partial U}{\partial x} - W - x \frac{\partial W}{\partial x} & ( 20 ) \\ \frac{\partial ( Zu )}{\partial y} = f \frac{\partial U}{\partial y} - x \frac{\partial W}{\partial y} & ( 21 ) \\ \frac{\partial ( Zv )}{\partial x} = f \frac{\partial V}{\partial x} - y \frac{\partial W}{\partial x} & ( 22 ) \\ \frac{\partial ( Zv )}{\partial y} = f \frac{\partial V}{\partial y} - W - y \frac{\partial W}{\partial y} & ( 23 )\end{matrix}$$

Governing Equations of Optical Flow Induced by Semi-rigid Motion

Substituting the partial derivatives of U and V obtained from Eqs. (20)-(23) in (19) results in

$$W = - [ ( \frac{{x}^{2}}{{x}^{2} + {y}^{2}} ) \frac{\partial ( Zu )}{\partial x} + ( \frac{xy}{{x}^{2} + {y}^{2}} ) ( \frac{\partial ( Zu )}{\partial y} + \frac{\partial ( Zv )}{\partial x} ) + ( \frac{{y}^{2}}{{x}^{2} + {y}^{2}} ) \frac{\partial ( Zv )}{\partial y} ] \qquad ( 24 )$$

From Eqs. (20) and (21), using Eqs. (16) and (17) one obtains

$$x \frac{\partial ( Zu )}{\partial x} + y \frac{\partial ( Zu )}{\partial y} = {f}^{2} \frac{\partial W}{\partial x} - W \qquad ( 25 )$$

Using Eq. (24), Eq. (25) becomes

$${xy}^{2} P ( x , y ) ( \frac{\partial ( Zu )}{\partial x} - \frac{\partial ( Zv )}{\partial y} ) + yQ ( x , y ) \frac{\partial ( Zu )}{\partial y} - yR ( x , y ) \frac{\partial ( Zv )}{\partial x} + {f}^{2} ( {x}^{2} + {y}^{2} ) [ {x}^{2} \frac{{\partial }^{2} ( Zu )}{\partial {x}^{2}} + xy ( \frac{{\partial }^{2} ( Zu )}{\partial x \partial y} + \frac{{\partial }^{2} ( Zv )}{\partial {x}^{2}} ) + {y}^{2} \frac{{\partial }^{2} ( Zv )}{\partial x \partial y} ] = 0 \qquad ( 26 )$$

where, P(x, y)=y²+x²+2f², Q(x, y)=y²(x²+y²)+f²(y²−x²) and R(x, y)=x²(x²+y²)+²(x²−y²).
Similarly, one can obtain from Eqs. (22) and (23), upon using Eqs. (16), (18) and (25)

$${x}^{2} yP ( x , y ) ( \frac{\partial ( Zv )}{\partial y} - \frac{\partial ( Zu )}{\partial x} ) + xQ ( x , y ) \frac{\partial ( Zu )}{\partial y} - xR ( x , y ) \frac{\partial ( Zv )}{\partial x} + {f}^{2} ( {x}^{2} + {y}^{2} ) [ {x}^{2} \frac{{\partial }^{2} ( Zu )}{\partial x \partial y} + xy ( \frac{{\partial }^{2} ( Zu )}{\partial {y}^{2}} + \frac{{\partial }^{2} ( Zv )}{\partial x \partial y} ) + {y}^{2} \frac{{\partial }^{2} ( Zv )}{\partial {y}^{2}} ] = 0 \qquad ( 27 )$$

Let I(x, y) denote the intensity of the field quantity (light, for example) that is used to detect the optical flow. Then, the well-known optical flow constraint can be written in the following form

$$Z \frac{\partial I}{\partial t} + ( Zu ) \frac{\partial I}{\partial x} + ( Zv ) \frac{\partial I}{\partial y} = 0 \qquad ( 28 )$$

Equations (26), (27) and (28) constitute the governing equations for optical flow in the present formulation, which need to be solved for obtaining the unknown quantities u, v, and Z. Note that in Eqs. (26) and (27) the focal length f appears as a parameter.

Behaviour Near the Origin in the Image Plane

Equations (24), (26) and (27) seem to indicate singular behaviour near the origin [(x, y)=(0, 0)] in the image plane. To investigate this further, one first transforms these equations from the Cartesian coordinates (x, y) to the cylindrical coordinates (r, φ) with the intention of analysing the behaviour as r→0. Thus, introducing cylindrical coordinates, one obtains from Eqs. (24), (26) and (27)

$$\begin{matrix}W = - cos φ \frac{\partial ( Zu )}{\partial r} - sin φ \frac{\partial ( Zv )}{\partial r} & ( 29 ) \\ ( {r}^{2} + {f}^{2} ) sin φ [ sin φ \frac{\partial ( Zu )}{\partial r} - cos φ \frac{\partial ( Zv )}{\partial r} ] = {f}^{2} sin φ [ cos φ \frac{{\partial }^{2} ( Zu )}{\partial r \partial φ} + sin φ \frac{{\partial }^{2} ( Zv )}{\partial r \partial φ} ] - {f}^{2} r cos φ [ cos φ \frac{{\partial }^{2} ( Zu )}{\partial {r}^{2}} + sin φ \frac{{\partial }^{2} ( Zv )}{\partial {r}^{2}} ] & ( 30 ) \\ ( {r}^{2} + {f}^{2} ) cos φ [ cos φ \frac{\partial ( Zv )}{\partial r} - sin φ \frac{\partial ( Zu )}{\partial r} ] = - {f}^{2} cos φ [ cos φ \frac{{\partial }^{2} ( Zu )}{\partial r \partial φ} + sin φ \frac{{\partial }^{2} ( Zv )}{\partial r \partial φ} ] - {f}^{2} r sin φ [ cos φ \frac{{\partial }^{2} ( Zu )}{\partial {r}^{2}} + sin φ \frac{{\partial }^{2} ( Zv )}{\partial {r}^{2}} ] & ( 31 )\end{matrix}$$

Now, setting r=0 in both Eqs. (30) and (31) leads to

$$cos φ \frac{\partial ( Zv )}{\partial r} - sin φ \frac{\partial ( Zu )}{\partial r} = cos φ \frac{{\partial }^{2} ( Zu )}{\partial r \partial φ} + sin φ \frac{{\partial }^{2} ( Zv )}{\partial r \partial φ} \qquad ( 32 )$$

In other words, the singularity at the origin leads to a reduction in the number of equations. That the behaviour of the optical flow velocity at the origin is singular can also be seen from Eqs. (13) and (14) by setting x=0 and y=0. Equations (13) and (14) show that the optical flow velocity components u and v are independent of W at the origin. Thus, infinitely many values for W leads to the same values for u and v. This singular behaviour of the optical flow at the origin is well documented in the literature.

It can be checked from Eqs. (30) and (31) that if r≠0 then the equations are independent and a unique solution is feasible. For the case where r=δ, with δ>0 and δ²<<δ, one obtains (by neglecting the r² terms) from Eqs. (30) and (31)

$$\begin{matrix}sin φ [ sin φ \frac{\partial ( Zu )}{\partial r} - cos φ \frac{\partial ( Zv )}{\partial r} ] = sin φ [ cos φ \frac{{\partial }^{2} ( Zu )}{\partial r \partial φ} + sin φ \frac{{\partial }^{2} ( Zv )}{\partial r \partial φ} ] - r cos φ [ cos φ \frac{{\partial }^{2} ( Zu )}{\partial {r}^{2}} + sin φ \frac{{\partial }^{2} ( Zv )}{\partial {r}^{2}} ] & ( 33 ) \\ cos φ [ cos φ \frac{\partial ( Zv )}{\partial r} - sin φ \frac{\partial ( Zu )}{\partial r} ] = - cos φ [ cos φ \frac{{\partial }^{2} ( Zu )}{\partial r \partial φ} + sin φ \frac{{\partial }^{2} ( Zv )}{\partial r \partial φ} ] - r sin φ [ cos φ \frac{{\partial }^{2} ( Zu )}{\partial {r}^{2}} + sin φ \frac{{\partial }^{2} ( Zv )}{\partial {r}^{2}} ] & ( 34 )\end{matrix}$$

Remark 1: By imposing an additional constraint such as continuity of u or v at the origin one can also overcome the singularity at the origin.
Remark 2: Even though Equations (33) and (34) are two independent equations, they do not have an explicit dependence on the focal length f.
Remark 3: Equations (30) and (31) show that the optical flow velocity components depend on the focal length f in a non-linear fashion.
Remark 4: Because of the singular behaviour of the governing equations at the origin, care must be exercised in selecting the numerical scheme as well as the coordinate system in which the governing equations will be solved. From the above discussion, it is clear that cylindrical polar coordinates are probably a better set of coordinates than the rectangular Cartesian coordinates. Moreover, one may have to pack points near the origin to better resolve this region.

The governing equations for optical flows induced by semi-rigid body motions have been derived. These equations retain the singular behaviour at the origin that is inherent in the epipolar coordinate transformation. The behaviour of the governing equations in the vicinity of the origin and far away from the origin indicates that one can obtain unique optical flow solutions. For numerically solving the optical flow equations it appears that the cylindrical polar coordinate system is preferable over the Cartesian coordinate system.

The equations derived above provide a method of estimating optical flow induced by semi-rigid motion. In a preferred embodiment, a first image of a scene is obtained. This can be done with a camera or it can be an image stored electronically. A second image of the same scene is also obtained at a later instant in time. The first and second images can be instantaneous images or time-averaged and/or space-averaged images. Pixels are then selected one by one from each of the scenes in the same order and the optical flow at each pixel is calculated using the equations:

$${xy}^{2} P ( x , y ) ( \frac{\partial ( Zu )}{\partial x} - \frac{\partial ( Zv )}{\partial y} ) + yQ ( x , y ) \frac{\partial ( Zu )}{\partial y} - yR ( x , y ) \frac{\partial ( Zv )}{\partial x} + {f}^{2} ( {x}^{2} + {y}^{2} ) [ {x}^{2} \frac{{\partial }^{2} ( Zu )}{\partial {x}^{2}} + xy ( \frac{{\partial }^{2} ( Zu )}{\partial x \partial y} + \frac{{\partial }^{2} ( Zv )}{\partial {x}^{2}} ) + {y}^{2} \frac{{\partial }^{2} ( Zv )}{\partial x \partial y} ] = 0$$

$${x}^{2} yP ( x , y ) ( \frac{\partial ( Zv )}{\partial y} - \frac{\partial ( Zu )}{\partial x} ) + xQ ( x , y ) \frac{\partial ( Zu )}{\partial y} - xR ( x , y ) \frac{\partial ( Zv )}{\partial x} + {f}^{2} ( {x}^{2} + {y}^{2} ) [ {x}^{2} \frac{{\partial }^{2} ( Zu )}{\partial x \partial y} + xy ( \frac{{\partial }^{2} ( Zu )}{\partial {y}^{2}} + \frac{{\partial }^{2} ( Zv )}{\partial x \partial y} ) + {y}^{2} \frac{{\partial }^{2} ( Zv )}{\partial {y}^{2}} ] = 0$$

$$and$$

$$Z \frac{\partial I}{\partial t} + ( Zu ) \frac{\partial I}{\partial x} + ( Zv ) \frac{\partial I}{\partial y} = 0$$

In other words, optical flow is estimated by obtaining first and second scenes from a camera or other device and then calculating the optical flow velocity components and depth using the foregoing equations.

In a second embodiment, a first image of a scene is obtained. A second image of the same scene is also obtained at a later instant in time. The first and second images can be instantaneous images or time-averaged and/or space-averaged images. Pixels are then selected one by one from each of the scenes in the same order and the optical flow at each pixel is calculated using the equations:

$$( {r}^{2} + {f}^{2} ) sin φ [ sin φ \frac{\partial ( Zu )}{\partial r} - cos φ \frac{\partial ( Zv )}{\partial r} ] = {f}^{2} sin φ [ cos φ \frac{{\partial }^{2} ( Zu )}{\partial r \partial φ} + sin φ \frac{{\partial }^{2} ( Zv )}{\partial r \partial φ} ] - {f}^{2} r cos φ [ cos φ \frac{{\partial }^{2} ( Zu )}{\partial {r}^{2}} + sin φ \frac{{\partial }^{2} ( Zv )}{\partial {r}^{2}} ]$$

$$( {r}^{2} + {f}^{2} ) cos φ [ cos φ \frac{\partial ( Zv )}{\partial r} - sin φ \frac{\partial ( Zu )}{\partial r} ] = - {f}^{2} cos φ [ cos φ \frac{{\partial }^{2} ( Zu )}{\partial r \partial φ} + sin φ \frac{{\partial }^{2} ( Zv )}{\partial r \partial φ} ] - {f}^{2} r sin φ [ cos φ \frac{{\partial }^{2} ( Zu )}{\partial {r}^{2}} + sin φ \frac{{\partial }^{2} ( Zv )}{\partial {r}^{2}} ]$$

$$Z \frac{\partial I}{\partial t} + ( cos θ + sin θ ) Zu \frac{\partial I}{\partial r} + ( \frac{1}{{r}^{2}} - \frac{sin θ}{r} ) Zv \frac{\partial I}{\partial θ} = 0$$

The foregoing equations can also be recast with respect to a numerically or otherwise generated coordinate system, also known as a structured grid. Such systems include orthogonal coordinate systems and nonorthogonal coordinate systems. Additionally, the equations can be recast with respect to unstructured grids.

The images and scenes used in the present invention can be obtained and stored in Cartesian and non-Cartesian pixel arrangements.

The present invention further comprises computing the physical velocity components U, V, and W subsequent to the computation of optical flow velocity components and the physical depth using equations

$$u = \frac{ⅆ x}{ⅆ t} = \frac{fU - xW}{Z}$$

$$v = \frac{ⅆ y}{ⅆ t} = \frac{fV - yW}{Z} and$$

$$W = - [ ( \frac{{x}^{2}}{{x}^{2} + {y}^{2}} ) \frac{\partial ( Zu )}{\partial x} + ( \frac{xy}{{x}^{2} + {y}^{2}} ) ( \frac{\partial ( Zu )}{\partial y} + \frac{\partial ( Zv )}{\partial x} ) + ( \frac{{y}^{2}}{{x}^{2} + {y}^{2}} ) \frac{\partial ( Zv )}{\partial y} ]$$

respectively.

This embodiment of the invention can be used to track multiple objects in relative motion with respect to each other that are visible in both images due to the fact the U, V, and W are point functions. Further, a three dimensional recreation of the scene can be computed using the equations

$$X = \frac{xZ}{f} and Y = \frac{yZ}{f} .$$

The present invention also includes an apparatus for calculating optical flow using the foregoing equations. Such an apparatus includes a camera for obtaining the images and a computer with hardware or software for implementing the above equations. Programming of the computer is within the skill of one trained in the art having the benefit of this disclosure.

While the above equations have been derived using the optical flow constraint, equations can also be derived using specular reflection or an equation involving a measured quantity other than light intensity. Several alternate formulations can be seen in Beauchemin and Barron (The Computation of Optical Flow, ACM Computing Surveys, 27(3):433-467 (1966)). Such equations are also with the scope of the present invention.

While the invention has been described with respect to the presently preferred embodiments, it will be appreciated by those skilled in the art that various modifications and changes can be made to the specific embodiments using the principles set forth herein.

1. A method of estimating optical flow induced by semi-rigid motion comprising:
obtaining a first image of a scene and selecting pixels one by one within said image;
obtaining a second image of said scene and selecting the pixels in the same order as in said first image; and
calculating optical flow at each pixel using the equations
$${xy}^{2} P ( x , y ) ( \frac{\partial ( Zu )}{\partial x} - \frac{\partial ( Zv )}{\partial y} ) + yQ ( x , y ) \frac{\partial ( Zu )}{\partial y} - yR ( x , y ) \frac{\partial ( Zv )}{\partial x} + {f}^{2} ( {x}^{2} + {y}^{2} ) [ {x}^{2} \frac{{\partial }^{2} ( Zu )}{\partial {x}^{2}} + xy ( \frac{{\partial }^{2} ( Zu )}{\partial x \partial y} + \frac{{\partial }^{2} ( Zv )}{\partial {x}^{2}} ) + {y}^{2} \frac{{\partial }^{2} ( Zv )}{\partial x \partial y} ] = 0$$
$${x}^{2} yP ( x , y ) ( \frac{\partial ( Zv )}{\partial y} - \frac{\partial ( Zu )}{\partial x} ) - xQ ( x , y ) \frac{\partial ( Zu )}{\partial y} + xR ( x , y ) \frac{\partial ( Zv )}{\partial x} + {f}^{2} ( {x}^{2} + {y}^{2} ) [ {x}^{2} \frac{{\partial }^{2} ( Zu )}{\partial x \partial y} + xy ( \frac{{\partial }^{2} ( Zu )}{\partial {y}^{2}} + \frac{{\partial }^{2} ( Zv )}{\partial x \partial y} ) + {y}^{2} \frac{{\partial }^{2} ( Zv )}{\partial {y}^{2}} ] = 0$$
$$and$$
$$Z \frac{\partial I}{\partial t} + ( Zu ) \frac{\partial I}{\partial x} + ( Zv ) \frac{\partial I}{\partial y} = 0$$

2. The method of claim 1 wherein the equations are initially recast with respect to a numerically or otherwise generated structured orthogonal coordinate system, also known as structured grid.

3. The method of claim 1 wherein the equations are initially recast with respect to a numerically or otherwise generated structured nonorthogonal coordinate system, also known as structured grid.

4. The method of claim 1 wherein the equations are initially recast with respect to a numerically or otherwise generated unstructured grid with the governing equations expressed in terms of the unstructured grid.

5. A method of estimating optical flow comprising:
obtaining first and second scenes;
calculating optical flow velocity components and depth using the equations
$${xy}^{2} P ( x ; y ) ( \frac{\partial ( Zu )}{\partial x} - \frac{\partial ( Zv )}{\partial y} ) + yQ ( x , y ) \frac{\partial ( Zu )}{\partial y} - yR ( x , y ) \frac{\partial ( Zv )}{\partial x} + {f}^{2} ( {x}^{2} + {y}^{2} ) [ {x}^{2} \frac{{\partial }^{2} ( Zu )}{\partial {x}^{2}} + xy ( \frac{{\partial }^{2} ( Zu )}{\partial x \partial y} + \frac{{\partial }^{2} ( Zv )}{\partial {x}^{2}} ) + {y}^{2} \frac{{\partial }^{2} ( Zv )}{\partial x \partial y} ] = 0$$
$${x}^{2} yP ( x , y ) ( \frac{\partial ( Zv )}{\partial y} - \frac{\partial ( Zu )}{\partial x} ) - xQ ( x , y ) \frac{\partial ( Zu )}{\partial y} + xR ( x , y ) \frac{\partial ( Zv )}{\partial x} + {f}^{2} ( {x}^{2} + {y}^{2} ) [ {x}^{2} \frac{{\partial }^{2} ( Zu )}{\partial x \partial y} + xy ( \frac{{\partial }^{2} ( Zu )}{\partial {y}^{2}} + \frac{{\partial }^{2} ( Zv )}{\partial x \partial y} ) + {y}^{2} \frac{{\partial }^{2} ( Zv )}{\partial {y}^{2}} ] = 0$$
$$and$$
$$Z \frac{\partial I}{\partial t} + ( Zu ) \frac{\partial I}{\partial x} + ( Zv ) \frac{\partial I}{\partial y} = 0$$

6. The method of claim 5 wherein the equations are initially recast with respect to a numerically or otherwise generated structured orthogonal coordinate system, also known as structured grid.

7. The method of claim 5 wherein the equations are initially recast with respect to a numerically or otherwise generated structured nonorthogonal coordinate system, also known as structured grid.

8. The method of claim 5 wherein the equations are initially recast with respect to a numerically or otherwise generated unstructured grid with the governing equations expressed in terms of the unstructured grid.

9. A method of estimating optical flow induced by semi-rigid motion comprising:
obtaining a first image of a scene and selecting pixels one by one within said image;
obtaining a second image of said scene and selecting the pixels in the same order as in said first image; and
calculating optical flow at each pixel using the equations
$$( {r}^{2} + {f}^{2} ) sin φ [ sin φ \frac{\partial ( Zu )}{\partial r} - cos φ \frac{\partial ( Zv )}{\partial r} ] = {f}^{2} sin φ [ cos φ \frac{{\partial }^{2} ( Zu )}{\partial r \partial φ} + sin φ \frac{{\partial }^{2} ( Zv )}{\partial r \partial φ} ] - {f}^{2} r cos φ [ cos φ \frac{{\partial }^{2} ( Zu )}{\partial {r}^{2}} + sin φ \frac{{\partial }^{2} ( Zv )}{\partial {r}^{2}} ]$$
$$( {r}^{2} + {f}^{2} ) cos φ [ cos φ \frac{\partial ( Zv )}{\partial r} - sin φ \frac{\partial ( Zu )}{\partial r} ] = - {f}^{2} cos φ [ cos φ \frac{{\partial }^{2} ( Zu )}{\partial r \partial φ} + sin φ \frac{{\partial }^{2} ( Zv )}{\partial r \partial φ} ] - {f}^{2} r sin φ [ cos φ \frac{{\partial }^{2} ( Zu )}{\partial {r}^{2}} + sin φ \frac{{\partial }^{2} ( Zv )}{\partial {r}^{2}} ]$$
$$Z \frac{\partial I}{\partial t} + ( cos θ + sin θ ) Zu \frac{\partial I}{\partial r} + ( \frac{1}{{r}^{2}} - \frac{sin θ}{r} ) Zv \frac{\partial I}{\partial θ} = 0$$

10. A method of estimating optical flow comprising:
obtaining first and second scenes;
calculating optical flow velocity components and depth using the equations
$$( {r}^{2} + {f}^{2} ) sin φ [ sin φ \frac{\partial ( Zu )}{\partial r} - cos φ \frac{\partial ( Zv )}{\partial r} ] = {f}^{2} sin φ [ cos φ \frac{{\partial }^{2} ( Zu )}{\partial r \partial φ} + sin φ \frac{{\partial }^{2} ( Zv )}{\partial r \partial φ} ] - {f}^{2} r cos φ [ cos φ \frac{{\partial }^{2} ( Zu )}{\partial {r}^{2}} + sin φ \frac{{\partial }^{2} ( Zv )}{\partial {r}^{2}} ]$$
$$( {r}^{2} + {f}^{2} ) cos φ [ cos φ \frac{\partial ( Zv )}{\partial r} - sin φ \frac{\partial ( Zu )}{\partial r} ] = - {f}^{2} cos φ [ cos φ \frac{{\partial }^{2} ( Zu )}{\partial r \partial φ} + sin φ \frac{{\partial }^{2} ( Zv )}{\partial r \partial φ} ] - {f}^{2} r sin φ [ cos φ \frac{{\partial }^{2} ( Zu )}{\partial {r}^{2}} + sin φ \frac{{\partial }^{2} ( Zv )}{\partial {r}^{2}} ]$$
$$Z \frac{\partial I}{\partial t} + ( cos θ + sin θ ) Zu \frac{\partial I}{\partial r} + ( \frac{1}{{r}^{2}} - \frac{sin θ}{r} ) Zv \frac{\partial I}{\partial θ} = 0$$

11. The method of any of claims 1, 5 or 9-10 wherein the optical flow constraint is replaced with an equation involving specular reflection.

12. The method of any of claims 1, 5 or 9-10 wherein the optical flow constraint is replaced with another equation involving a measured quantity other than light intensity.

13. The method of claim 1 wherein the images are obtained using a non-Cartesian pixel arrangement.

14. The method of any of claim 1 wherein the governing equations are solved in software.

15. The method of any of claim 1 wherein the solution procedure for the governing equations is implemented in hardware.

16. The method of any of claim 1 wherein the solution procedure for the governing equations is partly implemented in software and partly in hardware.

17. The method of any of claim 1 further comprising computing the physical velocity components U, V, and W subsequent to the computation of optical flow velocity components and the physical depth using equations
$$u = \frac{ⅆ x}{ⅆ t} = \frac{fU - xW}{Z}$$
$$v = \frac{ⅆ y}{ⅆ t} = \frac{fV - yW}{Z} and$$
$$W = - [ ( \frac{{x}^{2}}{{x}^{2} + {y}^{2}} ) \frac{\partial ( Zu )}{\partial x} + ( \frac{xy}{{x}^{2} + {y}^{2}} ) ( \frac{\partial ( Zu )}{\partial y} + \frac{\partial ( Zv )}{\partial x} ) + ( \frac{{y}^{2}}{{x}^{2} + {y}^{2}} ) \frac{\partial ( Zv )}{\partial y} ]$$

18. The method of claim 17 further comprising tracking multiple objects in relative motion with respect to each other that are visible in both frames due to the fact that U, V, and W are point functions.

19. The method of claim 17 further comprising computing a three dimensional recreation of the scene using the equations
$$X = \frac{xZ}{f} and Y = \frac{yZ}{f} .$$

20. An apparatus for estimating optical flow comprising:
a camera for obtaining first and second images;
a calculator for estimating optical flow between said first and second images using the equations:
$${xy}^{2} P ( x ; y ) ( \frac{\partial ( Zu )}{\partial x} - \frac{\partial ( Zv )}{\partial y} ) + yQ ( x , y ) \frac{\partial ( Zu )}{\partial y} - yR ( x , y ) \frac{\partial ( Zv )}{\partial x} + {f}^{2} ( {x}^{2} + {y}^{2} ) [ {x}^{2} \frac{{\partial }^{2} ( Zu )}{\partial {x}^{2}} + xy ( \frac{{\partial }^{2} ( Zu )}{\partial x \partial y} + \frac{{\partial }^{2} ( Zv )}{\partial {x}^{2}} ) + {y}^{2} \frac{{\partial }^{2} ( Zv )}{\partial x \partial y} ] = 0$$
$${x}^{2} yP ( x , y ) ( \frac{\partial ( Zv )}{\partial y} - \frac{\partial ( Zu )}{\partial x} ) - xQ ( x , y ) \frac{\partial ( Zu )}{\partial y} + xR ( x , y ) \frac{\partial ( Zv )}{\partial x} + {f}^{2} ( {x}^{2} + {y}^{2} ) [ {x}^{2} \frac{{\partial }^{2} ( Zu )}{\partial x \partial y} + xy ( \frac{{\partial }^{2} ( Zu )}{\partial {y}^{2}} + \frac{{\partial }^{2} ( Zv )}{\partial x \partial y} ) + {y}^{2} \frac{{\partial }^{2} ( Zv )}{\partial {y}^{2}} ] = 0$$
$$and$$
$$Z \frac{\partial I}{\partial t} + ( Zu ) \frac{\partial I}{\partial x} + ( Zv ) \frac{\partial I}{\partial y} = 0$$

21. The apparatus of claim 20 wherein the equations are initially recast with respect to a numerically or otherwise generated structured orthogonal coordinate system, also known as structured grid.

22. The apparatus of claim 20 wherein the equations are initially recast with respect to a numerically or otherwise generated structured nonorthogonal coordinate system, also known as structured grid.

23. The apparatus of claim 20 wherein the equations are initially recast with respect to a numerically or otherwise generated unstructured grid with the governing equations expressed in terms of the unstructured grid.

24. An apparatus for estimating optical flow comprising:
a camera for obtaining first and second images;
a calculator for estimating optical flow between said first and second images using the equations:
$$( {r}^{2} + {f}^{2} ) sin φ [ sin φ \frac{\partial ( Zu )}{\partial r} - cos φ \frac{\partial ( Zv )}{\partial r} ] = {f}^{2} sin φ [ cos φ \frac{{\partial }^{2} ( Zu )}{\partial r \partial φ} + sin φ \frac{{\partial }^{2} ( Zv )}{\partial r \partial φ} ] - {f}^{2} r cos φ [ cos φ \frac{{\partial }^{2} ( Zu )}{\partial {r}^{2}} + sin φ \frac{{\partial }^{2} ( Zv )}{\partial {r}^{2}} ]$$
$$( {r}^{2} + {f}^{2} ) cos φ [ cos φ \frac{\partial ( Zv )}{\partial r} - sin φ \frac{\partial ( Zu )}{\partial r} ] = - {f}^{2} cos φ [ cos φ \frac{{\partial }^{2} ( Zu )}{\partial r \partial φ} + sin φ \frac{{\partial }^{2} ( Zv )}{\partial r \partial φ} ] - {f}^{2} r sin φ [ cos φ \frac{{\partial }^{2} ( Zu )}{\partial {r}^{2}} + sin φ \frac{{\partial }^{2} ( Zv )}{\partial {r}^{2}} ]$$
$$Z \frac{\partial I}{\partial t} + ( cos θ + sin θ ) Zu \frac{\partial I}{\partial r} + ( \frac{1}{{r}^{2}} - \frac{sin θ}{r} ) Zv \frac{\partial I}{\partial θ} = 0$$

25. The apparatus of any of claims 20 or 24 wherein the optical flow constraint is replaced with an equation involving specular reflection.

26. The apparatus of any of claims 20 or 24 wherein the optical flow constraint is replaced with another equation involving a measured quantity other than light intensity.

27. (canceled)

28. (canceled)

29. (canceled)

30. (canceled)

31. (canceled)

32. (canceled)

33. (canceled)
